(19) United States
(12) Patent Application Publication
(10) Pub. No.: US 2026/0134445 A1
(43) Pub. Date: May 14, 2026

(54) METHOD

(71) Applicant: TOYOTA JIDOSHA KABUSHIKI KAISHA, Toyota-shi (JP)

(72) Inventors: Kenki UEDA, Tokyo-to (JP); Hideki KAWAI, Tokyo-to (JP); Yuma ISHINO, Hachioji-shi (JP)

(73) Assignee: TOYOTA JIDOSHA KABUSHIKI KAISHA, Toyota-shi (JP)

(21) Appl. No.: 19/326,731

(22) Filed: Sep. 12, 2025

(30) Foreign Application Priority Data
Sep. 30, 2024 (JP) 2024-171380

(51) Int. Cl. G06Q 30/0201; G06V 20/52; G10L 15/22

(52) U.S. Cl. CPC G06Q 30/020121; G06V 20/52; G10L 15/22

(57) ABSTRACT

An information processing apparatus detects customer information of a customer visiting a store using one or more sensors installed in the store. The information processing apparatus then determines attribute information of the customer from the detected customer information. The information processing apparatus then predicts degree of purchasing motivation of the customer for a product in the store based on the attribute information.

### CROSS-REFERENCE TO RELATED APPLICATION

This application claims priority to Japanese Patent Application No. 2024-171380, filed on Sep. 30, 2024, the entire contents of which are incorporated herein by reference.

### TECHNICAL FIELD

The present disclosure relates to a method.

### BACKGROUND

Technology for predicting purchasing motivation of customers is known. For example, Patent Literature (PTL) 1 discloses an advertising distribution control apparatus that predicts the purchasing motivation based on the timing of the acquisition of gift certificates by customers and the remaining amount.

### CITATION LIST

### Patent Literature

PTL 1: JP 2019-168880 A

### SUMMARY

In recent years, with the development of machine learning and other technologies, improvement in technology for predicting purchasing motivation of customers is desired.

It would be helpful to improve technology for predicting purchasing motivation of customers.

A method according to an embodiment of the present disclosure is a method performed by an information processing apparatus, the method including:
detecting customer information of a customer visiting a store using one or more sensors installed in the store;
determining attribute information of the customer from the detected customer information; and
predicting degree of purchasing motivation of the customer for a product in the store based on the attribute information.

According to an embodiment of the present disclosure, technology for predicting purchasing motivation of customers is improved.

### BRIEF DESCRIPTION OF THE DRAWINGS

In the accompanying drawings:

FIG. 1 is a block diagram illustrating a schematic configuration of an information processing apparatus according to the present disclosure; and

FIG. 2 is a flowchart illustrating operations of the information processing apparatus according to the present disclosure.

### DETAILED DESCRIPTION

Hereinafter, an embodiment of the present disclosure will be described.

### Outline of Embodiment

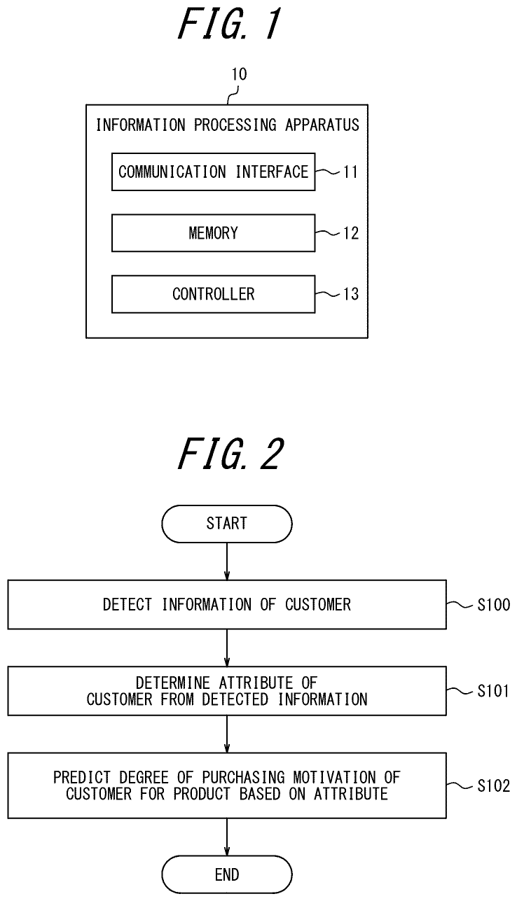

A configuration of an information processing apparatus 10 according to the present embodiment will be described with reference to FIG. 1. The information processing apparatus 10 is a computer, such as a server apparatus or a personal computer (PC), or other general purpose or dedicated electronic device. The information processing apparatus 10 provides services for use by the staff of a store, such as a vehicle dealership, for example. The information processing apparatus 10 may be a terminal apparatus used by users of the Service who are staff members of the store, a server belonging to a cloud computing system, or may be composed of terminal apparatus and a server.

First, an outline of the present embodiment will be described, and details thereof will be described later. The information processing apparatus 10 detects customer information of a customer visiting a store using one or more sensors installed in the store. Next, the information processing apparatus 10 determines attribute information of the customer from the detected customer information. The information processing apparatus 10 then predicts degree of purchasing motivation of the customer for a product in the store based on the attribute information.

Conventional technology requires prior knowledge of customer information in order to predict purchasing motivation of a customer visiting a store. In contrast, according to the present embodiment, the purchasing motivation of the customer is predicted using information on the customer detected using one or more sensors installed in the store. Therefore, even when customer information cannot be acquired in advance, it is possible to predict the purchasing motivation of the customer. In addition, the predicted purchasing motivation of the customer is real-time. Therefore, according to the present embodiment, the technology for predicting purchasing motivation of customers is improved in that purchasing motivation of customers can be predicted even when customer information cannot be acquired in advance, and the purchasing motivation is in real time. In addition, improved technology for predicting purchasing motivation of customers could reduce the man-hours required by stores to deal with customers with low purchasing motivation.

Next, a configuration of the information processing apparatus 10 will be described in detail.

### Configuration of Information Processing Apparatus

The information processing apparatus 10 includes a communication interface 11, a memory 12, and a controller 13.

The communication interface 11 includes at least one communication interface for connecting to a network. The communication interface is compliant with a mobile communication standard such as the 4th generation (4G) standard or the 5th generation (5G) standard, for example, but is not limited to these. The communication interface 11 receives information to be used for the operations of the information processing apparatus 10, and transmits information obtained by the operations of the information processing apparatus 10. The communication interface 11 enables the information processing apparatus 10 to transmit and receive information via the network to other devices, such as one or more sensors installed in a store, for example.

The memory 12 includes one or more memories. The memories are, for example, semiconductor memories, magnetic memories, optical memories, or the like, but are not limited to these. The memories included in the memory 12 may each function as, for example, a main memory, an auxiliary memory, or a cache memory. The memory 12 stores any information used for operations of the information processing apparatus 10. For example, the memory 12 may store a system program, an application program, embedded software, or the like. The information stored in the memory 12 may be updated with, for example, information acquired from the network via the communication interface 11.

The controller 13 includes at least one processor, at least one field-programmable gate array (FPGA) or other programmable circuit, at least one application specific integrated circuit (ASIC) or other dedicated circuit or any combination thereof. The processor is a general purpose processor such as a central processing unit (CPU) or a graphics processing unit (GPU), or a dedicated processor dedicated to specific processing. The controller 13 executes processes related to the operations of the information processing apparatus 10 while controlling the components of the information processing apparatus 10.

### Flow of Operations of Information Processing Apparatus

Operations of the information processing apparatus 10 according to the present embodiment will be described with reference to FIG. 2.

S100: The controller 13 of the information processing apparatus 10 detects the customer information of a customer visiting a store using one or more sensors installed in the store.

The “one or more sensors” may include any sensor capable of detecting customer information of customers inside the store, including, but not limited to, surveillance cameras capable of capturing images inside the store and microphones capable of recording conversations inside the store. The one or more sensors may not be installed in the store, but may be devices or other devices carried by store staff. For example, one or more sensors may include, but are not limited to, a camera and/or microphone on a terminal apparatus used by staff, or a microphone worn on the body by staff.

The “customer information” may include, for example, the customer's in-store behavior detectable by surveillance cameras, such as the customer's route of movement inside the store, the amount of time the customer spends looking at a product, etc., and may include conversational speech inside the store detectable by a microphone.

S101: The controller 13 determines attribute information of the customer from the detected customer information.

The “attribute information” may be information about any attribute that can be predicted from the customer's in-store behavior and conversational speech. For example, attributes may include, but are not limited to, the customer's age, family structure, clothing, budget, purpose of store visit, level of interest in the product, and any other information that can be used to predict degree of purchasing motivation of the customer.

For example, if one or more sensors include a microphone, the controller 13 may determine attribute information by performing natural language processing and keyword detection processing on conversational speech inside the store. Specifically, the controller 13 may predict the customer's age, family structure, budget, purpose of visit, etc. by performing natural language processing and keyword detection processing on the conversational speech.

For example, if one or more sensors include a surveillance camera, the controller 13 may determine attribute information by performing image recognition processing on camera images captured by the surveillance camera. Specifically, the controller 13 may predict customer attire, in-store behavior, etc. by performing image recognition processing.

S102: The controller 13 predicts degree of purchasing motivation of the customer for the product in the store based on the attribute information.

For example, the controller 13 may store statistics on the degree of purchasing motivation for each age of the customer in the memory 12, and predict the statistics corresponding to the predicted age of the customer as the degree of purchasing motivation of the customer. For example, the controller 13 may also predict that the higher the predicted budget of the customers, the higher the purchasing motivation of the customers. For example, the controller 13 may predict that the more specific the predicted purpose of visit to the store by the customer is, for example, that the customer is considering a purchase by March, the higher the purchasing motivation. For example, the controller 13 may predict that the more formal the predicted attire of the customers is, the higher the purchasing motivation. For example, the controller 13 may predict that the more time and number of times the customer stays near the display position of the product, the higher the purchasing motivation of the customer for the product.

The “degree of purchasing motivation of a customer” may be expressed, for example, as “high”, “medium”, and “low” in descending order of purchasing motivation, or as an integer in any range from 5 to 1, or as a letter in any manner, such as, but not limited to, S, A, B, C, D, etc.

For example, the controller 13 may use AI to analyze the attribute information of a customer with a high degree of purchasing motivation, store the analyzed results in the memory 12, and predict the degree of purchasing motivation of the customer based on the analyzed results.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like contained in each component, each step, or the like can be rearranged without logical inconsistency, and a plurality of components, steps, or the like can be combined into one or a single component, step, or the like can be divided.

For example, an embodiment in which the configuration and operations of the information processing apparatus 10 in the above embodiment are distributed to multiple computers capable of communicating with each other can be implemented. For example, if the information processing apparatus 10 is composed of a terminal apparatus and a server, the terminal apparatus may perform some of the operations and the server may perform the operations that the terminal apparatus does not perform.

For example, in the embodiment described above, the controller 13 may display information indicating the predicted degree of purchasing motivation of the customer. Specifically, the controller 13 may display the degree of purchasing motivation of the customer, as predicted in S102, on the display of the terminal apparatus used by the user.

For example, in the embodiment described above, the controller 13 may perform the operations from S100 to S102 at regular time intervals and notify the user when the degree of purchasing motivation of the customer has changed. Notification to the user may be made, for example, by displaying a message to that effect on the display of the terminal apparatus used by the user, but any method, including but not limited to the above, may be employed. Instead of notifying the user, the controller 13 may indicate the degree of purchasing motivation of the customer to the user by, for example, displaying a graph or the like on the display of the terminal apparatus.

The “regular time intervals” include any time, such as 10 minutes, 1 hour, etc. The regular time intervals may be changeable. The controller 13 may perform operations from S100 to S102 in real time.

For example, an embodiment in which a general purpose computer functions as the information processing apparatus 10 according to the above embodiment can also be implemented. Specifically, a program in which processes for realizing the functions of the information processing apparatus 10 according to the above embodiment are written may be stored in a memory of the general purpose computer, and the program may be read and executed by a processor. Accordingly, the present disclosure can also be implemented as a program executable by a processor, or a non-transitory computer readable medium storing the program.

In the embodiment described above, the controller 13 may control a dialogue AI that outputs a response to text or voice input to the terminal apparatus by the user, a store staff member, based on the predicted degree of purchasing motivation of the customer. For example, the controller 13 may control the dialogue AI so that, by inputting the predicted degree of purchasing motivation into the dialogue AI in addition to the textual or spoken question text input by the user, the dialogue AI outputs a response text that takes the degree into account. According to such a configuration, the user can conduct appropriate negotiations or proposals according to the purchasing motivation of the customer by referring to the response text.

1. A method performed by an information processing apparatus, the method comprising:
detecting customer information of a customer visiting a store using one or more sensors installed in the store;
determining attribute information of the customer from the detected customer information; and
predicting degree of purchasing motivation of the customer for a product in the store based on the attribute information.

2. The method according to claim 1, further comprising displaying information indicating the predicted degree of the purchasing motivation of the customer.

3. The method according to claim 1, wherein
the one or more sensors include a microphone capable of detecting conversational speech inside the store,
the customer information includes the conversational speech,
the method further comprises performing natural language processing and keyword detection processing on the conversational speech, and
the information processing apparatus determines the attribute information from results of the natural language processing and the keyword detection processing.

4. The method according to claim 1, wherein
the one or more sensors include a surveillance camera capable of capturing images inside the store,
the customer information includes camera images captured by the surveillance camera,
the method further comprises performing image recognition processing on the camera images, and
the information processing apparatus determines the attribute information from a result of the image recognition processing.

5. A method according to claim 1, wherein
the method is performed by the information processing apparatus at regular time intervals, and
the method further comprises notifying a user in a case in which the degree of the purchasing motivation of the customer has changed.
